(19) United States
(12) Patent Application Publication
(10) Pub. No.: US 2006/0201979 A1
(43) Pub. Date: Sep. 14, 2006

(54) Shopping bag

(76) Inventor: Dieter Achilles, Neu-Isenburg (DE)

Correspondence Address: DORITY & MANNING, P.A., POST OFFICE BOX 1449, GREENVILLE, SC, 29602-1449, US

(21) Appl. No.: 11/412,660

(22) Filed: Apr. 27, 2006

(30) Foreign Application Priority Data
Apr. 27, 2005 (DE) 20 2005 006 858.6
Dec. 2, 2002 (DE) 20 2005 018 961.8

(51) Int. Cl. B65D 30/22; A45C 3/00; B60R 7/00

(52) U.S. Cl. 224/411; 383/38; 190/109

(57) ABSTRACT

The invention relates to a shopping bag with a floor, longitudinal walls opposite one another, transverse walls that are opposite to one another, and an opening that is opposite to the floor, incorporating at least one general compartment into which purchased items may be placed, having at least one carrying handle with which the bag can be carried and including a suspension device for the purpose of hanging the bag in the familiar shopping trolleys used at supermarkets, DIY hypermarkets and the like. The shopping bag has at least one thermally insulating cold compartment to take chilled or frozen goods and/or at least on bottle compartment, each of which may accept one commercially typical bottle of food or drink.

The invention relates to a shopping bag with a floor, longitudinal walls opposite one another, transverse walls that are opposite to one another, and an opening that is opposite to the floor, incorporating at least one general compartment into which purchased items may be placed, having at least one carrying handle with which the bag can be carried and including a suspension device for the purpose of hanging the bag in the familiar shopping trolleys used at supermarkets, DIY hypermarkets and the like.

Shopping bags of this type have been known for a considerable time. A carrier bag is described, for instance, in DE 82 01 173; this, in addition to carrying handles, also has a suspension device taking the form of two rails curved towards the outside and a transport container having the typical form of a bag into which shopping is placed. A bag of this type, suspended in the shopping trolley, can be filled with the purchased items directly at the supermarket till, after which it can be lifted out of the shopping trolley and placed in the boot of a car. Time-consuming re-packing of the goods is no longer required. Similar carrier bags are described in EP 0 976 343 B1 and in DE 79 18 907.

The purpose of the present invention is to improve shopping bags of the type described above.

The shopping bag of the type described above is improved through the inclusion of at least one thermally insulating cold compartment where chilled and frozen goods may be placed, and/or at least one bottle compartment able to hold a typical, commercial bottle of food or drink.

The particular advantage of the invention is that shopping bags in accordance with the invention are more appropriate for a large number of shopping situations than shopping bags for hanging in shopping trolleys of the type known until now. For this reason, specially designed compartments are provided in accordance with the invention: on the one hand there is at least one thermally insulating compartment for chilled and frozen items, and on the other hand, as an alternative or in addition, there are one or more special compartments each of which can hold a bottle.

The advantage of the inclusion of at least one cold compartment is, in particular, that not only may purchased goods of the type that should be stored at room temperature be handled and transported, but also chilled or frozen items. Due to its thermally insulating properties, the minimum of one cold compartment ensures that the temperature of the chilled or deep-frozen items that have been placed in it only slowly approach ambient temperature. In this way, the goods that have been purchased are effectively kept cold all the time on the way from the chilled cabinet or the deep freeze to the home refrigerator or deep freeze, without the purchaser having to transfer the goods out of the shopping trolley into a special bag after having passed the till. Packing the goods that are to be kept cold into a dedicated freezer bag that is also taken on the shopping trip is indeed a familiar method. The handling of this kind of bag at the till, however, is awkward, since, after passing the till, this additional bag must be held with at least one hand, and must be held open in order to insert the goods.

Until now it has only been possible to use bags that accord with the present state of the art and suspended in a shopping trolley for goods that do not have to be kept cold. In addition, it is also necessary to take along the cold bag of the type that is awkward to handle.

The advantage of the presence of one or more bottle compartments is, again, that it is not necessary to pack the bottles awkwardly into a bag that, with difficulty is held open with one hand. Instead, the bottles can simply be placed into the individual compartments of the bag that is suspended, and therefore held open, and that this bag can then be transferred from the shopping trolley to the car. If the bottles are placed in the familiar, suspended shopping bags, a significant risk of breakage is presented. Delicate goods, moreover, are compressed and damaged by the bottles.

The one or more bottle compartments are designed specially to house one bottle per compartment; these may be ordinary, commercial milk or beer bottles or the like. When seen from above, therefore, the bottle compartments are favourably square in shape.

In accordance with one favourable implementation, the minimum of one cold compartment is not the same as the minimum of one general compartment—in other words, the cold compartment and the general compartment are separate from one another. The chilled or frozen goods can thus be placed into the one or more cold compartments, whereas vegetables, fruit, bread and so forth may be placed in the one or more general compartments. In contrast with the use of a familiar cold bag and a conventional shopping bag (with or without a suspension facility) there is thus the additional advantage that only a single bag is necessary.

When a large amount of shopping is being purchased, it is also possible to use two bags in accordance with the invention.

In accordance with one favourable implementation, one or more general compartments can be provided in addition to a number of bottle compartments. In this way the bottles can be placed in an upright position in their compartments, while the other items can be placed, separately from the bottles, in the one or more general compartments.

In one favourable implementation, at least one cold compartment and at least one bottle compartment are each located on one wall of the bag, favourably on the opposing longitudinal walls, so that the compartments are themselves opposite one another. A bag of this type is therefore suitable for a wide range of applications, since bottles, chilled goods and other items can be placed into it. Moreover, on an occasion when, for instance, bottles are not being transported, a bottle compartment can be used instead as a compartment for delicate goods, such as a cucumber. When chilled or frozen goods are not being purchased, the minimum of one cold compartment can also be used to transport goods that do not in fact have to be kept cold. Between the cold compartment or compartments and the bottle compartment or compartments it is, moreover, favourable to incorporate a general compartment in the intermediate space, where goods other than chilled goods or bottles may be placed.

In an alternative design of the shopping bag in accordance with the invention, all the bag's receptacles take the form of cold compartments. In this case, the shopping bag is a single cold bag, designed to be suspended in a shopping trolley. In the case of one particular design of this sort, only a single cold compartment (or receptacle) is provided, in accordance with which the longitudinal and transverse walls at the sides of the bag are thermally insulating all the way round.

The shopping bag in the form of a cold bag can also be divided into a number of small cold compartments, in which case they may all have the same size, or may be of different sizes. These cold compartments may be separated by walls, and these may also be thermally insulating. The user can then—whenever necessary—place goods at ambient temperature into one cold compartment, and items that are to be kept cold in the other cold compartment. Otherwise the items at the higher temperature would warm up for those items that are to be kept cold. This version of the bag can therefore be used in many ways.

It is also possible in a bag with bottle compartments for all the compartments in the back to be designed as bottle holders. If one compartment is provided for each bottle, it is possible, for instance, for 4×4 compartments to be fitted, and therefore for 16 bottles to be placed in the bag.

Goods can be placed into the cold compartment or compartments and the bottle compartment or compartments through an opening that opens upwards, so that handling is as easy as possible. This results in the maximum ease of use of the shopping bag in accordance with the invention, since in this case the minimum of one cold compartment or bottle compartment can easily have the chilled or frozen items or the bottles placed in it when the shopping bag is suspended in a trolley. The customer can then take the goods out of the cabinet or the deep freeze and place them in the corresponding compartment, later placing the goods on the conveyor belt at the till, and finally place them back into the minimum of one compartment. The effort in this case is minimised.

The walls of the minimum of one cold compartment and/or bottle compartment favourably have, when the shopping bag is suspended, a degree of stiffness, so that goods can be placed into them with one hand, and so that the compartment does not have to be held open with the other hand.

Optimum cooling can be achieved if a lid to cover the minimum of one cold compartment, favourably along with an appropriate fastener to close the compartment by means of the lid, are provided. Only a small amount of heat can then be exchanged between the external surroundings and the cold compartment, being unable to pass through slots or other openings.

There are a number of ways in which the cold compartment can be closed. Zips, hook-and-loop fasteners, clip fasteners, button closers and the like may be mentioned here.

A lid and a lid fastener can also be included in the version of the bag that has integrated bottle compartments. A lid of this sort is not, however, as important as it is for the cold compartment.

At least one cold compartment or bottle compartment is, in accordance with one favourable implementation, located within the shopping bag, preferably in the area of one of the shopping bag's longer sides. In this case, the neighbouring wall of the cold compartment or of the bottle compartment on the one hand, and the matching longitudinal wall of the shopping bag on the other hand, can lie flat against one another, and can be sown or welded. Alternatively, the corresponding outer wall of the shopping bag and one wall, or part of the wall, of the cold compartment or bottle compartment can in fact be identical.

In another version, at least one cold compartment is located on the outside of the longitudinal transverse wall. In accordance with the implementation of this type, the cold compartment can be fastened in the upper region of this longitudinal or transverse wall, which means that when the shopping bag is suspended, the cold compartment can be located outside the shopping trolley, while the general compartment or compartments, or the minimum of one bottle compartment for purchased items that do not need to be kept cold, is located inside the shopping trolley. This arrangement increases the total capacity of the bag.

It is favourable if at least one cold compartment has dimensions such that it can hold at least one pizza box of the usual commercial size.

Since the frozen items in particular, due to their usual portion size and their packaging, tend to require considerable space, it is favourable for the cold compartment to extend over almost the full height and/or width of the shopping bag.

In the case of bottle compartments it is also helpful if these extend over almost the full height of the bag.

It is favourable for the longitudinal and transverse walls of the shopping bag to consist of polyester, since this material is, on the one hand, economical in price, and on the other hand can easily be bundled up. It is also very resistant to tearing, and therefore extremely useful for everyday applications.

The walls of the minimum of one cold compartment favourably have at least an internal padding, bordered on the inside of the cold compartment by PVC sheet, or by an aluminum layer, or by some other material that holds down the temperature in the cold compartment. The filling in the intermediate space can even consist merely of an air cushion. The outer sides of the walls of the cold compartment may consist of PVC, polyester, or of another suitable material. PVC and aluminum have good thermally insulating properties, and prevent the goods in the cold compartment from warming up quickly, or heat from penetrating into the cold compartment.

It is also both possible and favourable for at least one internal face of the walls of the minimum of one cold compartment to be coated with a layer that reflects thermal radiation, or to consist of a material with the property of reflecting thermal radiation, so that the temperature in the minimum of one cold compartment only rises slowly over a long period. Favourably it is also possible—perhaps perhaps as an alternative—to maintain the thermal conduction, i.e. the transfer of heat to the inner wall of the cold compartment through direct contact with the chilled or frozen goods, at as low a level as possible through an appropriate choice of materials.

It is entirely possible for there to be no filling and no intermediate space, i.e. for at least one of the walls of the cold compartment to comprise a single layer. In that case it is necessary for appropriate insulating measures to be taken, favourably on the internal face of the wall, to ensure that the temperature of the chilled or frozen goods in the minimum of one cold compartment does not rise too quickly. In this case, therefore, it is appropriate to use a layer that reflects heat radiation or an appropriate wall material which, alternatively or additionally, offers poor thermal conductivity, i.e. a low thermal transfer resulting from direct contact with the chilled or frozen goods.

In a particularly favourable implementation, the suspension facility on each of the two longitudinal sides of the shopping bag has one hook piece to the outside and one underneath for the purposes of suspension in the shopping trolley.

These hook pieces are favourably each located on one of the rails that run along the two longitudinal upper edges of the bag. These rails give the bag a stable form in the direction of the length of the shopping trolley, so that the bag is open wide when suspended in the trolley.

Manufacture is simplified, and stability is increased, if the hook pieces and the rails are formed as a single piece.

It is favourable if hook-and-loop fasteners are positioned along the rails, facing one another and corresponding to one another, so that the top of the bag can be firmly closed when it is not suspended in a trolley. It is also possible for a hook-and-loop fastener to be provided, in the familiar manner, on at least one of the carrying handles in order to link together the areas where the handles are gripped, so making it easier to carry the bag.

In a further development in this respect, it is favourable for elastic material to be attached to the upper edges of the narrow or transverse sides of the bag, so that when the bag is suspended it is held open by the hook elements on its longitudinal sides, but that when it is no longer suspended the opening is narrowed by the tension of the elastic elements. When the bag is entirely empty it can therefore favourably be rolled up around the rails and may, for instance, be stored in a case that is included in a favourable implementation of the invention.

In one favourable implementation, the hook pieces are located between the two ends of each of the carrying handles. In one implementation, the carrying handles, made of flexible material, typically hang down outside the sides of the bag when the bag is suspended in the shopping trolley. Once shopping has been completed, these are then pulled upwards, so that the bag can easily be lifted out of the shopping trolley. Alternatively, the carrying handles are sufficiently stiff that they stand up, which means that they cannot accidentally fall down into the inside of the bag as it is being loaded, which might then make it awkward to lift them back out of the filled bag.

Favourable further developments of the invention are indicated through the features of the subsidiary claims.

The invention will be explained in more detail in what follows with the aid of the figures. The same references will be used for parts with the same function in the different figures. They show:

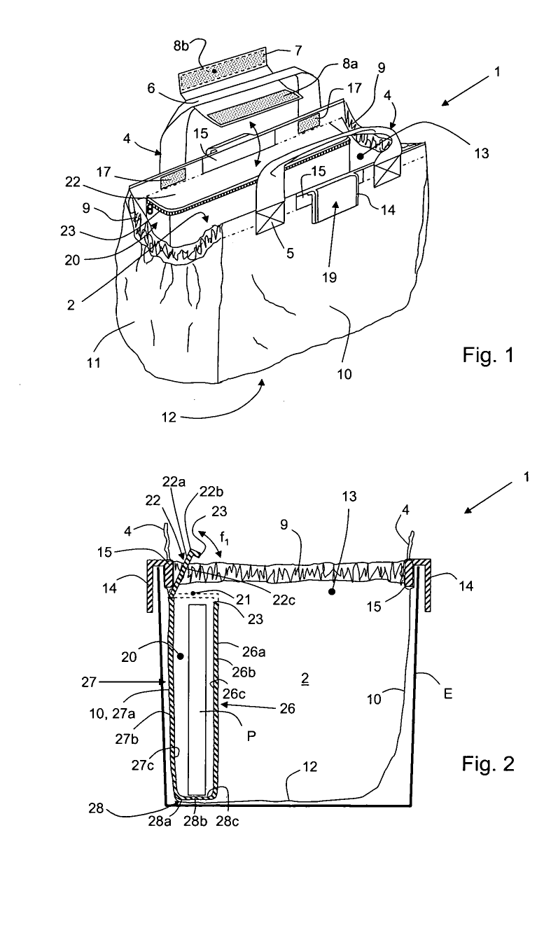

FIG. 1 A perspective view of a shopping bag in accordance with the invention;

FIG. 2 a longitudinal section of the view from the side of the bag shown in FIG. 1 suspended in a shopping trolley that is only partly shown;

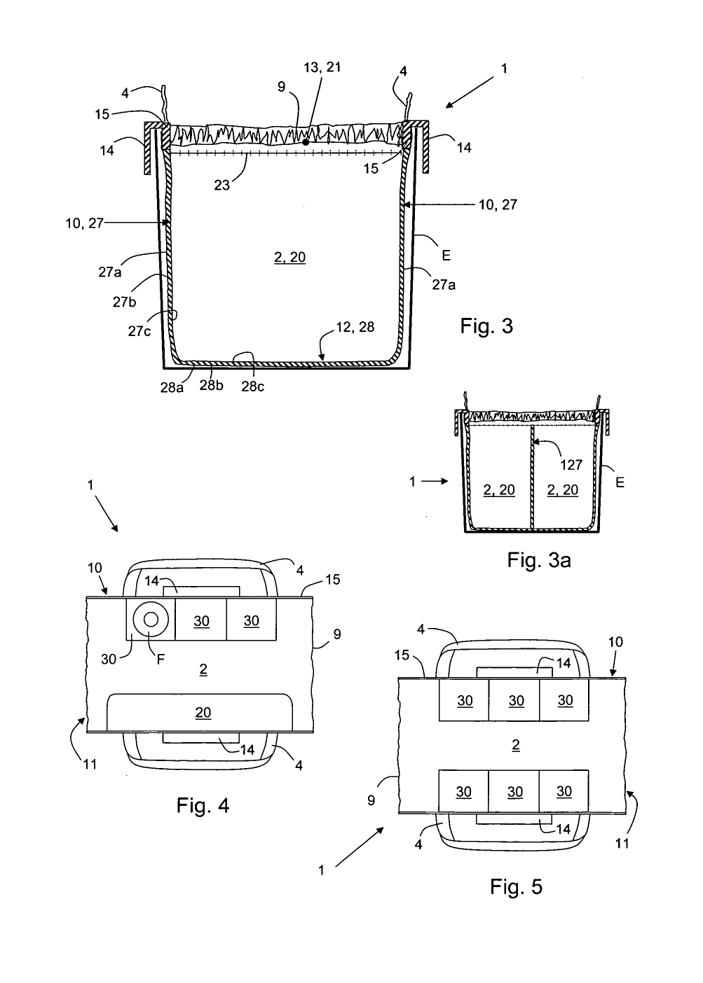

FIG. 3 a section of the view from the side of a second implementation of the bag in accordance with the invention suspended in a shopping trolley that is only partly shown;

FIG. 3a a side view of a modification of the implementation in accordance with FIG. 3;

FIG. 4 a view from above of a third implementation of the bag in accordance with the invention, shown schematically, and

FIG. 5 a view from above of a fourth implementation of the bag in accordance with the invention, shown schematically.

FIGS. 1 and 2 show a shopping bag 1 in accordance with the invention, one illustration showing a perspective view from above, the other illustration providing a sectional view from the side. This shows, primarily, a rectangular cross-section with two longitudinal sides 10 and two transverse or end faces 11, a floor 12 and an opening 13. The walls 10, 11 and the floor 12 define a general compartment 2 where purchased items can be placed, being inserted through the opening 13 into the bag 1. The material of the bag that holds the goods can, for instance, be made of a woven synthetic material (such as nylon or polyester) or of a plastic sheet. Other possible materials include, for instance, cotton or jute. On the upper edges of each of the longitudinal sides 10 the bag 1 has a carrying handle 4 (only part of which is suggested in FIG. 2), whose two ends 5 are fastened to the material of the bag using cross-seams. A flexible piece of material 7 is sown onto the gripping area 6 of one of the carrying handles 4; it has two mutually corresponding hook-and-loop fastening elements 8a and 8b, one on the inside and one on the outside, by means of which the two gripping areas 6 of the two carrying handles 4 can be held together.

Along the upper edge of the each of the longitudinal walls 10 there is a rail 15 made of a substantially rigid plastic material, giving the bag 1 the necessary stability. In the area of the face ends of the two rails 15 there are pieces of elastic material 9 sown to the material of the bag; these allow the bag 1 to be folded, when not in use, into a small space or to be rolled up so that it can favourably be housed to save space in a suitable bag made, for instance, of nylon. Hook pieces 14 facing to the outside and downwards are moulded as one piece at the centre of each of the rails 9; these create a suspension facility, by means of which the bag 1 can be suspended from the sides of a shopping trolley E, only partly shown on FIG. 2, in the familiar way (see FIG. 2). The side walls of the shopping trolley E thereby protrude into the space between the bag material and the inside of the hook piece 14. Additionally, holders 19 for advertising material, not displayed, such as printed cards, are positioned on the hook pieces.

In the implementation illustrated, the material of the bag is sown around the rails 15 on the two sides of the hook pieces 14, the seams being shown as dotted lines. In addition, sections of hook-and-loop fastener 17 are attached to the inside of the material that is sown around the rail, so that when the rails 15 are placed together they will engage, thus ensuring a secure closure of the top of the bag 1.

The shopping bag 1 has, in accordance with one aspect of the invention, a cold compartment 20 open to the top, and having in this case a substantially square shape, located between the longitudinal side 10 and the general compartment 2. The cold compartment 20 extends over almost the entire height and width of the bag 1. The opening 21 of the cold compartment can be covered by a lid 22; a zip 23 reversibly closes the lid 22 over the lower receptacle of the cold compartment 20, thus preventing undesirable thermal transfer.

The cold compartment 20 is located with its outward facing wall 27 against the inside of a longitudinal face 10 of the bag 1, and can therefore favourably be sewn or welded on along its edges. The inward-facing wall 26 of the cold compartment 20 borders against the general compartment 2. The floor 28 of the cold compartment 20 passes just above the floor 12 of the shopping bag 1.

The walls 26, 27, the floor of 28 and lid 22 of the cold compartment 20 are here formed in three parts. The same applies to the end walls of the cold compartment 20, which are only to be seen in FIG. 1. The outer walls 26a, 27a, 28a and 22a are here made of polyester, while the internal walls 26c, 27c, 28c and 22c are made of PVC or aluminum. A thermally insulating filling material 26b, 27b, 28b and 22b is located between these layers. The outer wall 27a of the cold compartment 20 is identical with the corresponding longitudinal wall 10 of the shopping bag 1.

The filling between the outer walls 26a, 27a, 28a and 22a and the inner walls 26c, 27c, 28c and 22c may also consist entirely of air.

An alternative implementation of a cold compartment, not illustrated, does not have either a double wall or a multi-layer wall with an intermediate space or spaces, but has a single-layered form. In this case it is necessary to take appropriate insulating measures at the walls to ensure that the temperature of the chilled or frozen goods in the corresponding cold compartment does not rise too quickly. It is helpful in this case for the insides of the walls to have a coating that reflects thermal radiation, or to use an appropriate wall material that favourably also (or perhaps—if this is sufficient—as an alternative) offers the lowest possible thermal transfer arising from direct contact with the chilled or frozen goods. These properties, moreover, are also offered by the double or multi-layer walls of the cold compartment in a shopping bag in accordance with the invention.

Due to its relatively thick walls, the cold compartment 20 takes the self-supporting rectangular shape mentioned above when the shopping bag 1 is suspended. Favourably at least one additional pizza can be placed in the compartment in addition to the one shown.

The cold compartment 20 is favourably of such dimensions that at least one pack P of deep frozen pizza fits in, as is suggested in FIG. 2.

When the bag 1 is used, it is suspended by means of the hook pieces 14 from the longitudinal sides of a conventional shopping trolley E (see FIG. 2), causing the elastic pieces 9 to be stretched and opening the top 13 of the bag. The user can now place those purchased items that do not have to be kept cold into the general compartment 2 and those that must be chilled or kept cold in the cold compartment 20. After insertion of the cold items, the lid 22 is favourably folded down, and may be closed with the zip 23.

At the till the user places the goods on the conveyor belt, and, after paying, returns them to the bag 1, grouped in the same way.

The bag 1 can be filled without undue haste, since it is held open by the hook pieces 14, and no awkward manoeuvring is needed to put the items away. The zip 23 is then favourably closed. It is now possible to push the bag 1 in the shopping trolley E to the car, or, after lifting it out of the shopping trolley E, to carry it there and place it in the boot. When it is removed from the shopping trolley E, the opening 13 of the bag 1 closes of its own accord due to the elastic pieces 9. Troublesome reloading out of the shopping trolley into a shopping bag after having passed the till is not necessary. Thanks to the insulation provided by the cold compartment 20, the chilled or frozen goods are kept cool or frozen from the moment they are first selected, and can thus be kept for longer.

FIG. 3 illustrates another implementation of the bag 1 in accordance with the invention, in which only one general compartment 2 is provided, which in this case is identical with the cold compartment 20. The whole of the shopping bag 1 is then a cold bag.

In the case of the bag 1 in accordance with FIG. 3, the longitudinal walls 10 and the transverse walls 11 of the bag 1 are identical with the longitudinal walls 27 and/or the transverse walls (not displayed, due to the sectional drawing) of the cold compartment 20. The same applies to the floor 12 of the bag 1 and the floor 28 of the cold compartment 20. The longitudinal walls 27, the transverse walls, and the floor 28 of the cold compartment 20 have—as in the implementations in accordance with FIGS. 1 and 2—outer walls 27a and 28a and inner walls 27c and 28c, and have thermally insulating filling located between them (in particular a soft, i.e. non-rigid, material) 27b and 28b.

Additionally, the shopping bag 1 has an opening 21 (identical with the opening 13 of the general compartment 2) which can be closed by a lid, not displayed, with the aid of a zip fastener 23 extending around the inner side of the cold compartment 20. In this case the lead extends over the entire opening 21.

In accordance with the alternative illustrated in FIG. 3a, which is substantially identical with the implementation in accordance with FIG. 3, there are two receptacles 2, implemented as cold compartments 20 and separated by a wall 127, which is also thermally insulating. This design leaves the useful option open to the user of being able to place goods at ambient temperature in the one cold compartment 20, whilst using the other cold compartment 20 for items that must be kept cold. If the wall 127 were not present, the warmer items would, undesirably, transfer some of their heat to the goods that are to be kept cold. This extends the number of ways in which this bag can be used, as it means that its use need not be restricted to chilled or frozen goods. It is, naturally, also perfectly possible to place only items at ambient temperature into the two cold compartments 20. It is, of course, also possible for there to be more than two receptacles or cold compartments 20. The size of these compartments may also be varied.

In the third implementation, shown schematically from above in FIG. 4, three bottle compartments 30 are illustrated, in accordance with the invention, opposite the cold compartment 20, each of which can hold a bottle F (illustrated as an example in one compartment 30), inserted from above. Between the compartments 20, 30, a general compartment 2 is provided; this can be used for goods that do not have to be chilled and are not in the form of bottles. The longitudinal wall 10 of the bag 1, and the neighbouring walls of the bottle compartments 30 are favourably sown and/or welded together. The walls of these bottle compartments 30 and the longitudinal wall 10 may also be fully or partly identical.

The fourth example of an implementation in accordance with FIG. 5 features two rows, each of three bottle compartments 30, where each row is arranged against the opposing longitudinal walls 10 of the bag 1. A general compartment 2 is provided between these rows.

The invention has been explained in more detail with the aid of particular examples of implementation. Further modifications can easily be made within the context of the claims. It is, for instance, conceivable that the receptacle 20 could be divided into individual compartments, where one of these compartments is used for vegetables, another for fruit, and another for other items. It would also be possible for a shopping bag in accordance with the invention to feature only bottle compartments 30, without one or more non-specific compartments 2 being provided. The thermally insulating property of the walls and the floor of the minimum of one cold compartment 20 can be achieved in a number of different ways, in particular by using suitable materials other than those described above. It is also possible for not all the walls and floors to be thermally insulating, but only a part or parts of the walls and floor. It is, it nevertheless, important that the temperature of the chilled or frozen goods placed in the minimum of one cold compartment only rises slowly, and that the goods therefore remain cool over the length of the journey home from the supermarket. It is also possible for the walls of the bottle compartments to be thermally insulating, to house, for instance, milk bottles in the bottle compartments.

1. A shopping bag with a floor (12), opposing longitudinal walls (10), opposing transverse walls (11) and an opening (13) opposite the floor (12), having at least one general compartment (2) into which purchased goods can be placed through the opening (13) and at least one carrying handle (4) for carrying the bag (1) manually, and with a suspension facility (14) with which the bag (1) can be suspended in familiar shopping trolleys (E) for use in supermarkets, DIY hypermarkets and the like, wherein there is at least one thermally insulating cold compartment (20) to take chilled or frozen goods (P) and/or at least one bottle compartment (30), each of which may accept one commercially typical bottle (F) of food or drink.

2-36. (canceled)
